(19) United States
(12) Patent Application Publication
(10) Pub. No.: US 2026/0120372 A1
(43) Pub. Date: Apr. 30, 2026

(54) SYSTEMS AND METHODS FOR NATURAL DISASTER IDENTIFICATION AND MANAGEMENT

(71) Applicant: Trident Sensing, Inc., Ogden, UT (US)

(72) Inventors: Stephen J. Pollard, Oakley, UT (US); Colin M. Pollard, Salt Lake City, UT (US); Lukas R. Majors, Salt Lake City, UT (US)

(73) Assignee: Trident Sensing, Inc., Ogden, UT (US)

(21) Appl. No.: 18/949,239

(22) Filed: Nov. 15, 2024

Related U.S. Application Data
(60) Provisional application No. 63/632,627, filed on Apr. 11, 2024.

(51) Int. Cl. G06T 11/65; G06T 7/00; G06T 7/73

(52) U.S. Cl. CPC G06T 11/65; G06T 7/0002; G06T 7/73; G06T 2207/10032; G06T 2207/20221; G06T 2207/30181; G06T 2207/30244

(57) ABSTRACT

A method for generating a map display for natural disaster monitoring includes collecting sensor data from a geographic area and assigning sensor data to one of a plurality of pixels. The collected data is preprocessed to remove unreliable or irrelevant data and then each pixel value is georeferenced to a location on the globe. The georeferenced data is aggregated according to location and time of collection and is assigned a quality score. The scored and georeferenced pixels are then aggregated into a map representing the best collected data for a geographic area during a period of time. The temporally aggregated map is then output for further use. A system for mapping a natural disaster includes airborne and ground sensors for collecting data over a geographic area, a ground control station, a geographic database, a weather database, a processor, and a remote server. The sensors include infrared, thermal, and camera sensors.

### CROSS-REFERENCE TO RELATED APPLICATIONS

This application claims priority to U.S. Provisional Patent Application No. 63/632,627, filed Apr. 11, 2024, which is hereby incorporated herein in its entirety.

### BACKGROUND OF THE INVENTION

### Field of the Invention

Embodiments of the disclosed invention relate to systems and methods for remote sensing, and more particularly to creating and distributing maps of natural disasters for incident identification and management.

### Relevant Background

To facilitate identification and management of natural disaster incidents, remote sensing devices mounted to airborne vehicles may be used to monitor affected terrain from high altitudes or long distances. Airborne vehicles used for such purposes include satellites, unmanned aerial vehicles, spacecraft, and aircraft. Various sensors and accompanying monitoring techniques may be used to provide information for specific applications. Many remote sensing techniques exist, each offering its own set of advantages and preferred applications. Remote sensing techniques may be used to identify signs of an emerging disaster incident, e.g., forest fires, floods, earthquakes, hurricanes, power outages, etc. They also may be used to monitor weather conditions, crop growth, or forest cover, or to monitor internal and external national security threats.

Use of remote sensing techniques for real-time disaster incident monitoring requires collection of large amounts of data over vast terrain, i.e., areas of interest, and transmission of the collected data to relevant personnel. Such collection and transmission of data is often difficult for several reasons. As an initial matter, image files alone do not always tell the entire story. Image files may fail to provide the context or experiential insight about the area of interest required for accurate monitoring of one or more parameters and performance of action planning, e.g., disaster prevention based on identified warning signs. The parameters may include accurately monitoring ambient temperature, relative humidity, or thermal scans that may indicate conditions conducive to the development of a potential disaster.

Another issue causing difficulty is that communications infrastructure in remote areas is frequently inadequate to support image transmission for real-time monitoring. Poor transmission rates usually causes users to seek higher bandwidth transmission equipment, or to reduce image quality. Non-commercial airborne vehicles do not typically come fitted with the equipment required to transmit large image files. Satellites may collect and transmit images, but image resolution is usually not at the granular scale needed to identify and monitor an emerging disaster incident.

Finally, the current state of art is unable to aggregate data from many available sources to prevent, or respond to, disasters. While many different data sources currently exist, the data generated from them is siloed and not usable in a coordinated fashion. This creates an onerously complex situation for responders, and delays analysis required to plan mitigation efforts. Therefore, the present state of art fails to address the need for high volume data collection and transmission from many disparate sources, and to accurately monitor affected terrain and to conduct timely disaster response.

It is apparent that what is needed are systems and methods for efficient data collection and transmission to enable real-time monitoring of the terrain for disaster incident identification and response. These and many other deficiencies of the prior art are addressed by one or more embodiments of the disclosed invention. Additional advantages and novel features of this invention are set forth in part in the description that follows, and in part will become apparent to those skilled in the art upon examination of the following specification or may be learned by the practice of the invention.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings attached following this description.

FIG. 1 depicts a block diagram of the components of a system for creating and distributing maps as used in embodiments of the disclosed invention.

FIG. 2 depicts a flowchart of at least a portion of a data aggregation process as used in embodiments of the disclosed invention.

FIGS. 3A and 3B depict at least a portion of a data prefiltering process for thermal imagery as used in embodiments of the disclosed invention.

FIG. 4 depicts a block diagram of at least a portion of a data georeferencing process as used in embodiments of the disclosed invention.

FIG. 5 depicts a block diagram of at least a portion of a data quality rating process as used in embodiments of the disclosed invention.

FIG. 6 depicts a block diagram of at least a portion of a data aggregation process as used in embodiments of the disclosed invention.

FIG. 7 depicts a block diagram of at least a portion of a data aggregation process as used in embodiments of the disclosed invention.

FIG. 8 depicts a block diagram of at least a portion of a disaster incident characterization process as used in embodiments of the disclosed invention.

FIGS. 9A and 9B depict an exemplary Graphical User Interface (GUI) display showing incident characterization as used in embodiments of the disclosed invention.

FIG. 10 depicts a flowchart of at least a portion of an exemplary data collection, processing, and export process as used in embodiments of the disclosed invention.

FIGS. 11A and 11B depict an example GUI display of an imaged disaster incident as used in embodiments of the disclosed invention.

FIG. 12 depicts an exploded side view of components of a sensor system as used in embodiments of the disclosed invention.

FIG. 13 depicts an exploded bottom view of components of a sensor system as used in embodiments of the disclosed invention.

FIG. 14 depicts a top view of components of a sensor system as used in embodiments of the disclosed invention.

FIG. 15 depicts a perspective top view of components of a sensor system as used in embodiments of the disclosed invention.

FIG. 16 depicts an exploded perspective bottom view of components of a sensor system as used in embodiments of the disclosed invention.

FIG. 17 depicts a perspective bottom view of components of a sensor system as used in embodiments of the disclosed invention.

FIG. 18 depicts a block diagram of an exemplary computing device as used in embodiments of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### DEFINITIONS

Satellite images are images from satellites that are not real-time, and view multiple areas with relatively longer time gaps between views as compared to aircraft sensor platforms.

Geo-stationary satellite images are satellite images with lower resolution because they taken from a relatively greater distance than from other satellites.

Sensor systems are comprised of one or more sensors that produce one or more data samples, or arrays of data samples, along with geometric information or metadata. Such data samples can be associated with their geographic locations.

Georeferencing is a process in which data samples are correlated with to respective locations on a model of the Earth by use of geometric samples corresponding to each data sample.

Time aggregation is a process by which disparate sensor readings are coordinated based on their time of collection. Geographic coverage of a region of interest is accomplished by selecting a representative pixel of data corresponding to a geographic area during a time interval.

### DETAILED DESCRIPTION

The inventions described herein are systems and methods for remote sensing, and more particularly to creating and distributing maps of geographical regions showing overlaid sensor data relevant to identification and management of natural disaster incidents.

Embodiments of the disclosed invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the disclosed invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the disclosed invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under”, or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### TACFI-RS

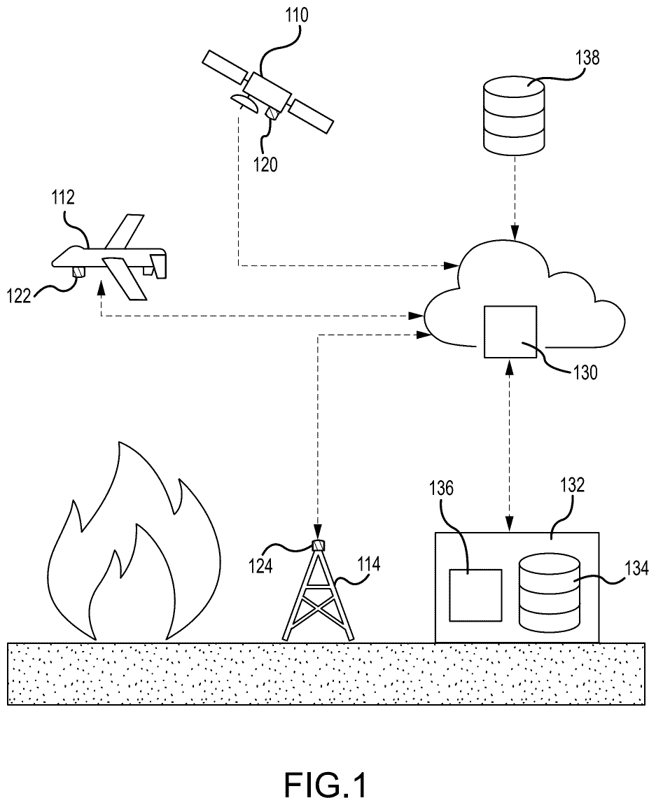

With reference to FIG. 1, the tactical fire remote sensing (TACFI-RS) system is an airborne wildfire mapping system that employs a source-agnostic approach to data collection, which allows system users to tap into or repurpose sensors 120, 122, on existing airborne platforms, such as a Low Earth Orbit (LEO) satellite 110, or a Very Low Earth Orbit (VLEO) satellite, an unmanned aerial vehicle (UAV) 112, a manned aerial vehicle, a commercial airliner, a hot air balloon, or a general aviation aircraft, to collect needed data. In addition, almost any aircraft, including UAVs, can be retrofitted to participate in the TACFI-RS system by fitting it with a small, lightweight sensor 122 for collecting relevant disaster incident data. Airborne sensor nodes are used in combination with positional data that is coordinated in time with sensor readings. Positional data is acquired from position, navigation, and timing (PNT) equipment located onboard the sensor or onboard the airborne platform. For example, a Global Positioning System (GPS) receiver, an inertial navigation system (INS), or other suitable system is used to acquire PNT data. Further, ground-based sensors 124 may also be used, for example, thermal imaging or temperature sensors mounted on existing water towers, communications towers, fire towers, or specially installed antenna masts or towers 114, etc., Such sensors perform data aggregation and compression locally via an incorporated microprocessor, or a processor in electronic communication with the sensor, to improve data transmission rates via existing communication systems, including a cellular network, satellite communication, radio network, an ethernet network, or line-of-sight communication.

The TACFI-RS system also includes a central infrastructure remote server 130 that may, for example, be situated on a local server, a cloud-based server, or other suitable computer equipment connected to the internet or local network. The remote server is connected to ground control station 132, which includes a holistic database 134 configured to store georeferenced maps of sensor readings. Also in communication with the remote server is at least one computer system 136 for performing system computational functions. The remote server 130 is connected to one or more ground-based sensors 124, including thermal image sensors and temperature sensors. Like airborne sensors, ground-based sensors are configured to generate signals associated with a potential or actual natural disaster incident. Also in some embodiments, in communication with the remote server is a weather database 138 that is configured to store weather characteristics associated with a geographical region of interest.

In addition to efficient data collection, TACFI-RS also provides for superior data aggregation, compression, and transmission (DACT) via a DACT protocol. Since the TACFI-RS system is source agnostic, incoming data must be efficiently collected, organized, and weighted, so that multiple sensors can be combined and displayed seamlessly to the user.

### DACT Protocol

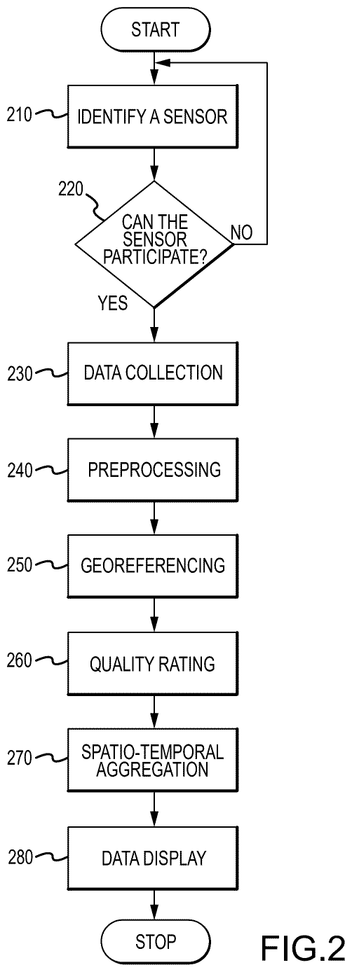

With reference to FIG. 2, the DACT protocol includes a series of logical steps. First, the system identifies a sensor node 210 and examines it to determine whether the sensor may contribute to the TACFI-RS environment 220. To be included, the device must be capable of logging time, position, and attitude data, and must include relevant sensor data, e.g., image, temperature, color, brightness, etc. In some embodiments, the system uses sensor systems that are previously assessed as capable of contribution to the TACFI-RS environment, and therefore it is unnecessary to perform the sensor identification and examination processes.

Data from airborne and ground sensors that are included in the system are collected 230, and then sent for preprocessing 240, which includes filtering functions to reduce false readings when used in subsequent steps, and to reduce the georeferencing workload by discarding false, irrelevant, or uninteresting data. Preprocessed data is then passed to a georeferencing step 250, which orients data according to geography. The georeferenced data is then passed to and a quality rating step 260, which is used to weight the collected data so that superior data is preferred for display over inferior data. The georeferenced and quality-rated data is then passed to a spatio-temporal aggregation step 270, which combines individual samples according to geographic area and selects higher-quality data to produce compressed aggregated maps. The data is then displayed 280 to the user in near-real time or output for other purposes.

### Data Collection

If data qualifies for inclusion in the characterization of a TACFI-RS environment, a geographic region of interest is sensed via an airborne or ground-based platform, and data samples are collected 230. Data samples are sensed, estimated, or generated values produced by sensor nodes that directly or indirectly represent information of interest to the end user, such as visual, thermal, or ultraviolet (UV) images. The sensed data includes samples that can be correlated to a point location or to a geographic region. In addition to sensed data, geometric samples and other metadata are also collected to facilitate georeferencing the visual data, and includes location, orientation, time, velocity, acceleration, and other suitable information about the sensed visual data. In some embodiments, depth information is collected to associate the image data with geographic elevation or distance from the sensor, or elevation data may be derived from a geographic model.

Data samples can be produced in higher-order structures such as arrays, wherein multiple correlated samples are tabulated in a data sample array, e.g., a 2-dimensional (2-D) data array. Data samples and arrays may be developed sequentially in time, so that each sensor node outputs samples that may overlap in a geographic region. Video samples may be represented as a series of 2-D data arrays that show change over time.

Alongside data sample collection, in some embodiments, weather characteristics are collected for the geographic region of interest for time periods that are relevant to, or overlap with, data sample collection. If weather information is used, collected weather characteristics are stored in the weather database. Relevant weather characteristics include wind speed and direction, high and low temperatures, and precipitation forecasts, and may be collected from the National Weather Service or other suitable source of weather information.

### Preprocessing

Once collected, the sensor data undergoes a preprocessing step 240, which includes filtering functions to reduce false readings when used in subsequent steps, and to reduce the georeferencing workload by discarding false, irrelevant, or uninteresting data. For example, if an estimated output of the system is wildfire location and the input consists of thermal images, the preprocessor may screen for and discard very cold readings that are unhelpful for determining fire location. By discarding such readings based on relevance, the system reduces the number of operations required for georeferencing.

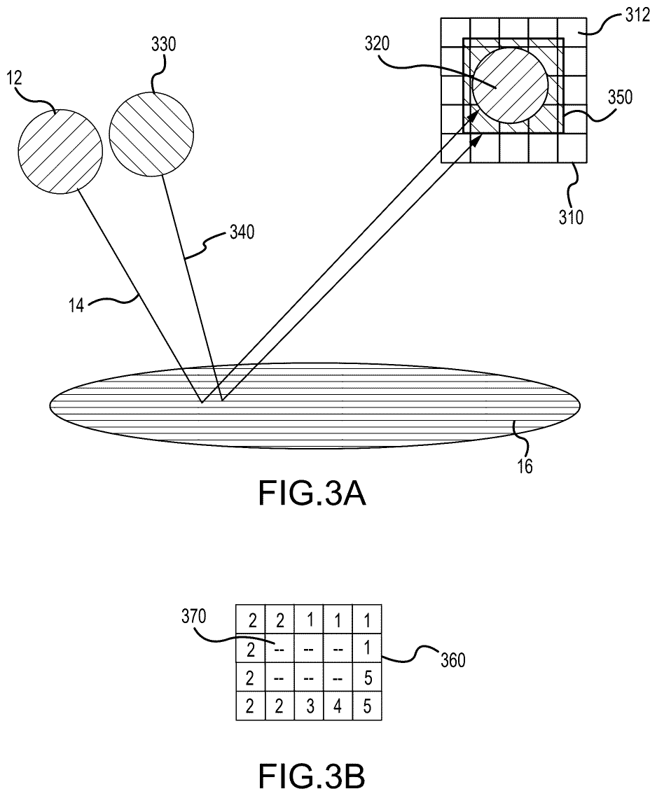

As another example, the preprocessor may screen for and discard artificially high thermal readings caused by sun reflection into the camera. Sun reflections can cause false positives or false negatives in subsequent layer processing, and therefore need to be addressed before georeferencing or raytracing. With reference to FIG. 3A, an example sun reflection preprocessing procedure is depicted. A thermal imaging sensor has an imaging plane 310 that is divided into pixels 312. The sun 12 sends light 14 toward a reflective surface 16, which reflects the light toward the sensor where an image 320 is detected in the imaging plane. The sensor calculates the sun's predicted position 330 as a function of time based on GPS time data and a solar positioning model. Based on the predicted position 330 and information about terrain located below the sensor location, the sensor calculates the primary and retroreflective angles of the predicted sunlight 340 to locate where the predicted reflection 350 would appear on the image plane.

In other words, because the sun's position and the sensor position are known, one can determine the location of the sun' reflection on the sensor. The predicted reflection is rendered as an area that maps onto some of the pixels 312 comprising the imaging plane. With reference to FIG. 3B, an example thermal image 360 is depicted wherein redacted pixels 370 located directly in the area of the reflection are masked or are given a null value. The image has thus been redacted to exclude the effect of the sun's reflection on the collected data. By reducing the presence of solar reflections on thermal imaging data, future steps in the method will be less influenced by information that is irrelevant to the presence and location of wildfires.

Similarly, in some sensor system mounts, the sensor may be partially obstructed by the platform, e.g., UAS, aircraft, tower, etc., on which it is mounted. In such cases, obstructed portions of the sensor imaging plane will collect false or irrelevant information. For example, a sensor system may be partially obstructed by aircraft exhaust, which would register as an artificially hot area on the imaging plane, and which could be mischaracterized as a wildfire. To mitigate such effects, a custom mask is created for each platform or platform type and is used to redact pixels, as discussed above for sun reflections.

### Data Aggregation and Compression

### Georeferencing

With further reference to FIG. 2, after preprocessing, remaining data samples are georeferenced, or orthorectified 250, to a common geographic map. Georeferenced data samples developed by such a process have been correlated with their respective geometric locations using a georeferencing process, so that the location on the planet from which the data sample originated is encoded with the data sample in discrete units. Georeferenced data samples could be, but are not limited to, visual or thermal imagery taken of the planet, correlated pixel-wise with the locations of each pixel on the planet.

The implementation of the georeferencing process may include, but is not limited to, ray tracing each pixel from a collected image to calculate intersections with a terrain model. A position and pointing angle of the data sample source is used to construct a ray that propagates from a pixel of the imaging plane and intersects a specific location on a representation of the planet's surface derived from the terrain model. The sensed visual data is then adjusted to match the accuracy of the common geographic map using the metadata and depth data from sensor readings. For example, a common sensor may have an inertial navigation solution that provides a location and pointing angle of the sensor. In this situation, a starting location and pointing angle of each ray belonging to a pixel can be generated and propagated to the ground. When the intersection points are calculated, the value of the common geographic map is assigned to the pixel's value. If multiple pixels intersect the same location on the map, a combination function is used to produce a single combined result.

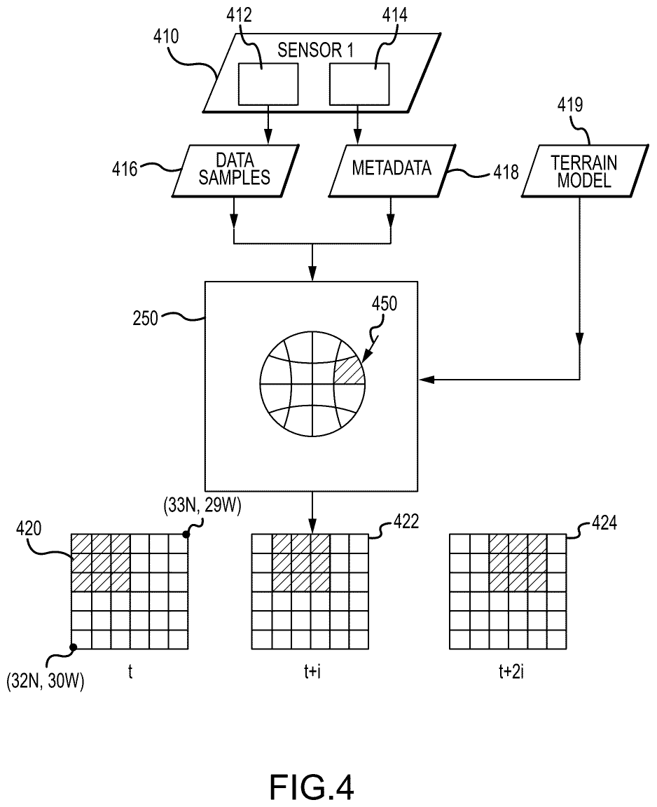

With reference to FIG. 4, a simplified block diagram depicts an exemplary process for georeferencing collected data samples according to embodiments of the disclosed invention. A sensor node 410 uses a first sensor 412 to collect a series of data samples 416. The first sensor is, for example, a thermal imaging camera and the data samples are thermal images captured at times t, t+i, t+2i, t+3i, and so on, where i is the interval between sample collections. The sensor node uses a second sensor 414 to collect metadata 418. The second sensor is, e.g., a PNT system, and the geometric data or metadata is platform roll, pitch, heading, latitude, longitude, and altitude. Using the metadata, the georeferencing module 250 performs ray tracing 450 to estimate a location for each thermal value. Then the module uses a geographic terrain model 419 to find where the ray-traced thermal value intersects the terrain model to assign each data value to a pixel on the terrain model. Each data pixel therefore represents a sample value for a geographic area. The result is a series of data maps 420, 422, 424 (three are shown), represented as a 2-D grid of pixels corresponding to a range of grid coordinates, e.g., latitudes and longitudes. For example, the maps may range from 32 Degrees (°) North latitude, 30° West longitude (32°N, 30°W) to (33°N, 29°W). Each data map has a time of collection and is spaced a set interval from the prior sample, so that map 1 420 is taken at a time t, map 2 422 is taken at time t+i, and map 3 424 is taken at t+2i. Together, data maps 1, 2, and 3 cover an area of land with some overlap among the maps.

In some embodiments, the sensor system is configured to use alternative grid schemes, such as the Universal Polar Stereographic (UPS) grid system, to improve the fidelity of the grid scheme to the geometry of the earth. For example, near the north and south poles, the latitude and longitude grid system becomes increasingly unusable for 1:1 mapping of a sensor pixel area to a discrete geographic area. In other areas, the latitude and longitude grid does not accurately reflect the non-spherical shape of the earth, which can result in poor pixel to geographic area representation. Multiple grid schemes are possible an contemplated to ensure that the system traces each pixel to a discretized geometry of the earth.

### Quality Rating System

The disclosed system displays a single, comprehensive view of the disaster area to the user, while also accepting input data from a wide variety of sources. To enable this capability, the system employs a quality rating system (FIG. 2, item 260). The quality rating system (QRS) is configured to internally weight and combine data from different sources so that the most important, or highest quality data are expressed to the user. Quality rating functions may be performed peripherally on individual sensor node processors, and centrally at the central system processor.

The QRS accounts for external and internal factors to assess the quality of collected sensor data. External factors are those outside the context of the individual sensor data quality, such as those factors involving atmospherics or sensor platform comparisons. One such external factor is the environmental conditions at the time of data acquisition, which may have a significant impact on data quality. For example, visual obscurants such as clouds, smoke, or fog present during a data collection would render the collected data of lower quality, whereas clear skies would render the data of higher quality. Similarly, the presence of turbulence at the time and altitude flown by a sensor platform would render collected data of lower quality, while the presence of smooth air would increase the data quality rating. Turbulence interferes with accurate georeferencing by introducing variability into the location and angle of the sensor.

Another external factor considered by QRS is heterogeneity of sensor capabilities. For example, because of their extreme altitude, satellite-based sensors generally have lower fidelity imaging than that available from aircraft-based sensors. On the other hand, satellite coverage is typically much broader than aircraft coverage, meaning some geographic areas may only have satellite data available. QRS therefore may score satellite data as lower quality than aircraft data, but in areas where only satellite data exists, satellite data is retained. In areas where both aircraft and satellite data exist, the aircraft data would be of higher quality than the satellite data, other factors being equal.

Another external factor accounted for by QRS is data recency. For purposes of disaster response, time is of the essence, and delay in data acquisition is of utmost importance. Nevertheless, older data is preferable to a complete lack of data, and therefore in some circumstances, areas of a map may only be covered by data with a long delay in processing or transmission. In the absence of more recent information, the QRS will retain older information collected from prior iterations of the timescale in geographic areas lacking current data. As such, the retained older data will be assigned a lower quality rating than they received when first collected due to degraded recency.

Yet another external factor considered by the QRS is the scale of different sensor readings. As a function of map generation, the system may aggregate multiple geographic regional maps into a larger composite regional map, or even a single global map. QRS therefore must reconcile different geographic scales. For high quality sensors, collected data is likely to be high resolution, and therefore may be more granular than the composite map. By contrast, lower quality sensors collect lower resolution data that are less granular than the composite map. QRS assigns a higher quality score to data having more granularity than the composite map, while data having lower granularity than the composite map receives a lower quality score.

An example of an internal factor, or a factor that is relevant to the data quality of an individual sensor, is sensor performance at the time of data acquisition. Camera systems, for example, produce images of varying quality based on the pose and location of the camera relative to the imaged area. Similarly, rotation by the camera, or high velocity over the ground, may cause blurring or streaking in the captured images. As another example, the imaging distance and resolution of the imaging platform will generate pixels of a certain size or area on the surface. Smaller pixel areas generally correlate to more precise measurements and increased quality. Likewise, noise present in the sensor output may also be considered, so that data from lower noise systems are preferred. Performance metrics may therefore be used to account for performance-related changes to data sample quality.

Another example of an internal factor considered is the altitude of the sensor platform. Data collected from sensor platforms flying at a higher altitude would receive a lower quality grade than data from a lower-flying aircraft other factors being equal. This is because lower altitude sensors collect more granular data. Another factor considered is the amount and nature of metadata available during collection. A set of visual data that included many metadata points would be ranked higher than the same visual data collected with few metadata points. The type of metadata available is also considered, for example, if the sensor platform lost GPS lock, and hence lost precise location information, data collected during that time would be considered very low quality or may be discarded.

Predicted interpretations of sensor data can also contribute to quality scoring. For example, a machine-learning model may be trained to predict the location of a wildfire based on thermal imaging data. Based on the received data, the model produces a map assigning a confidence score for the presence or absence of fire in a geographic location. Such confidence scoring may then be weighted into the quality metric.

The QRS tracks quality factors at the sensor node level through use of a quality map that exists alongside the data map assembled by the sensor and tracks a quality score for each data pixel. When a new sensor reading, e.g., a thermal image, is acquired, the relative quality of each pixel is tabulated, a quality score is assigned to the pixel and mapped. The quality score for the pixel is then used when determining which source supplies superior data for inclusion in the data map. Quality scoring is most important when combining overlapping images. For example, if pixels from a low-turbulence image overlap pixels from a high-turbulence image, i.e., the pixels represent the same geographic areas, the QRS would weigh the low-turbulence images to increase their contribution to the final image value for those pixels in the map. Quality information is therefore encoded in a map that is co-extensive with the sensor value map.

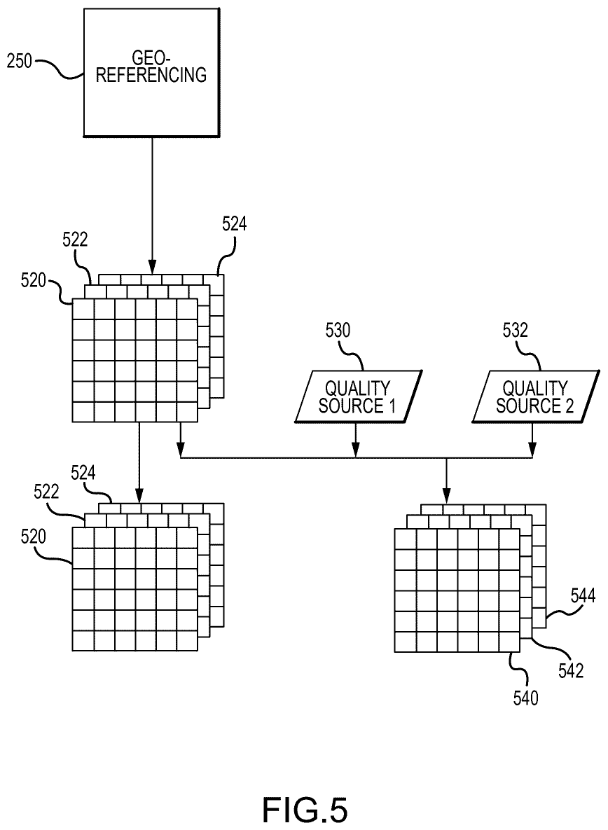

With reference to FIG. 5, a simplified block diagram depicts an exemplary process for creating a quality map according to embodiments of the disclosed invention. The QRS receives georeferenced data maps 520, 522, 524 from the georeferencing function (FIG. 2, item 250). Collected along with the sensor data are quality metrics that are supplied by one or more sources of quality data 530, 532 (two are shown). The quality source(s) may be sensors, such as GPS or INS, metadata, weather reports, or other sources indicative of data quality. The QRS takes data map 1 520, data map 2, 522 and data map 3 524, and assigns a quality score to each pixel of each data map to develop a series of quality maps 540, 542, 544, each corresponding to its respective data map. Accordingly, each pixel in quality map 1 540 contains a quality score for the corresponding pixel in data map 1 520, each pixel in quality map 2 542 contains a quality score for the corresponding pixel in data map 2 522, and so on.

Different methods may be used to assign a quality value to pixels in a quality map. For example, one method is to assign the quality score of the best sensor reading that contributed to that pixel. Another method is to assign a quality score representing a weighted average of the quality scores of the sensor readings that contributed to that pixel. The product of quality scoring by the QRS quality map that contains a quality score for each pixel in a corresponding data map that contains a sensor value for each pixel, wherein the quality score represents the value of each data pixel compared to nominal sensor values.

Not only do quality scores for individual pixels require weighting at the sensor node level, but quality scores must also be weighted at the system level when sensor data from multiple sensors is aggregated. Therefore, quality maps produced by individual sensor nodes are weighted together to develop a system quality map wherein each pixel is assigned a system quality score. Different assignment methods are possible and contemplated, however, one simple method would be to choose the sensor data pixel with the highest quality rating and designate the quality score for that data pixel as the system quality score for that pixel. Alternatively, the QRS may assign a system quality score that represents a weighted average of the quality scores of the different sensor readings that contributed to that pixel. In either case, the system would display the best available data for each pixel and a system user does not need to be concerned with the devices or conditions that produced the data.

While the data the aggregation and compression step FIG. 2, item 250 and quality rating step item 260 are described as sequential, other alternatives are possible and contemplated. In some embodiments, therefore, during each aggregation step quality scoring is considered to create the final output. Quality scoring is integrated into aggregation at both the sensor node levels and the global level. For each pixel location, the quality metrics for all of the contributing samples are combined to select the highest quality pixel for inclusion in map products. Alternatively, QRS outputs a set of aggregated quality metrics, so that the quality score of each contributing sample used to select the final pixel value is encoded and associated with the pixel.

QRS as described is a dynamic rating system capable of weighting sensor quality and various quality-influencing factors to select the best data available for a given geographic area, even if the only available data is of low quality. Because of this, the composite quality rating of data collected on a geographic area can dynamically shift the preferred source of the data, even if the selected sensor node is of lower nominal quality.

### Spatio-Temporal Aggregation

Next, multiple sensor readings are aggregated FIG. 2, item 260 according to geographic area and time using an aggregation software module. The aggregation module conducts two basic functions: multiple data samples are stacked according to a stacking process and combined using a weighting system. The aggregation module may be hosted on the sensor node processor, or may be hosted on the system's central processor. The aggregation module produces time-aggregated readings, rather than a constant stream of discrete sensor readings. Spatio-temporal aggregation includes combining georeferenced data samples in time to create a single georeferenced output representing the cumulative data observed by a sensor node during a time interval. Each participating sensor node is georeferenced to a common model of the planet so that the georeferenced outputs form a Temporally Aggregated Map (TAM), which is a geographic representation of data samples collected over the time interval.

The time interval for a TAM is typically set by a system user and is influenced by the time intervals of each sensor node contributing to the TAM. Each sensor node has a TAM duration parameter set automatically or by a user, for example 5 minutes, causing the sensor node to produce a TAM every 5 minutes that aggregates images taken since the previous TAM. When multiple TAMs contributed by different sensor nodes are transmitted to the central processor, TAM durations may be set at various lengths by a user. Users are presented options for different TAM durations, for example, 5 minutes, 15 minutes, 30 minutes, 1 hour, 4 hours, etc., allowing the user to visualize broader trends in the development of the disaster incident. Some embodiments include a negotiation protocol between the central processor and individual sensor nodes that allows the duration parameter to be dynamically adjusted depending on sensor node durations, sensor resolution, data transmission infrastructure, speed of disaster evolution, or other suitable factor.

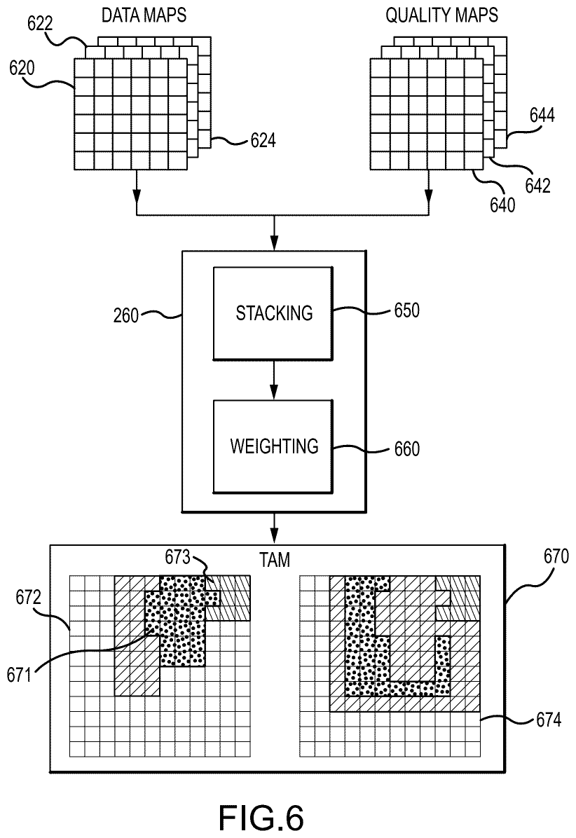

With reference to FIG. 6, a simplified block diagram depicts an exemplary process for creating a TAM according to embodiments of the disclosed invention. The aggregation module 260 receives a series of georeferenced data maps 620, 622, 624 and corresponding quality maps 640, 642, 644, where data map 1 620 is a sample for time t, map 2 622 is a sample for t+i, and map 3 624 is a sample for t+2i. In this example, the aggregation module will construct a TAM having a timestamp t, and a set duration of 2i. The duration is a parameter that is configurable by a system user and may be adjusted as required.

The module performs a stacking process 650 wherein the individual data maps are arranged in an overlapping pattern, so that the geographic area corresponding to each pixel is coordinated across the maps. For example, if a pixel in map 1 corresponds to the same geographic area as a pixel in map 2, those pixels would be assigned to the same location. In this way, discrete sensor readings are stacked so that samples taken from overlapping or adjacent geographic areas are coordinated to provide coverage of the combined geographic areas imaged in each sensor reading.

In situations where a multi-camera sensor node is used to perform a collection, the stacking process further includes a calibration step that allows the system to trace each pixel of each camera to the geographic model. The calibration step includes determining the precise orientation and lens distortion of each camera so that accurate ray tracing can be done. For example, the orientation of each pixel is determined relative to an INS reading to generate the pixel's location on the map. The calibration process further aids the combination of sensor readings from discrete sensor nodes into a combined field of view that is larger than each individual sensor node's field of view.

Using the stacked data maps and their corresponding quality maps, a weighting function 660 assesses the relative quality score of each pixel to determine the highest quality data pixel for each area of land represented. The aggregation module then combines the stacked and weighted data maps with their corresponding quality maps into a TAM 670. To do so, the aggregator first creates an empty or valueless map spanning the locations of all georeferenced pixels within the time period. Then for each pixel, the aggregator applies a combination function to select a single value for each pixel in the map. The TAM includes a data layer 672 wherein each pixel represents the highest quality data collected for each area of land during the time slice t to t+2i, and wherein the geographic area covered by the data layer is the combined geographic coverage of the individual data maps. For individual pixels with overlap, i.e., there are multiple samples with data for those pixels, e.g., 671, 673, the module selects a value based on the quality score of each contributing sample. The TAM also includes a quality layer 674, wherein each pixel represents the quality score of the corresponding pixel in the data layer. The aggregation module outputs the TAM 670 to the user interface, and to other functions, such as for use in applications affecting a wider or global geographic area.

In addition to broader geographic coverage, by aggregating readings together into longer “time slices”, a system user can observe longer term trends that may affect larger geographic regions as the sensor moves over the ground. Use of longer time slices also promotes aggregation of data from diverse, non-cooperating platforms operating in the geographic area, e.g., some sensor platforms may be slow to update, or others may possess too much latency for real-time use. What is more, aggregating sensor readings allows the redaction or removal of redundant data contained across sensor readings. For example, if a wildfire is imaged many times over the course of a minute, the fire will not fundamentally change during that time, and the unique information provided by each image is less valuable than the bandwidth required to transmit the images. By aggregating sensor readings in time, data is compressed by removing redundant observations.

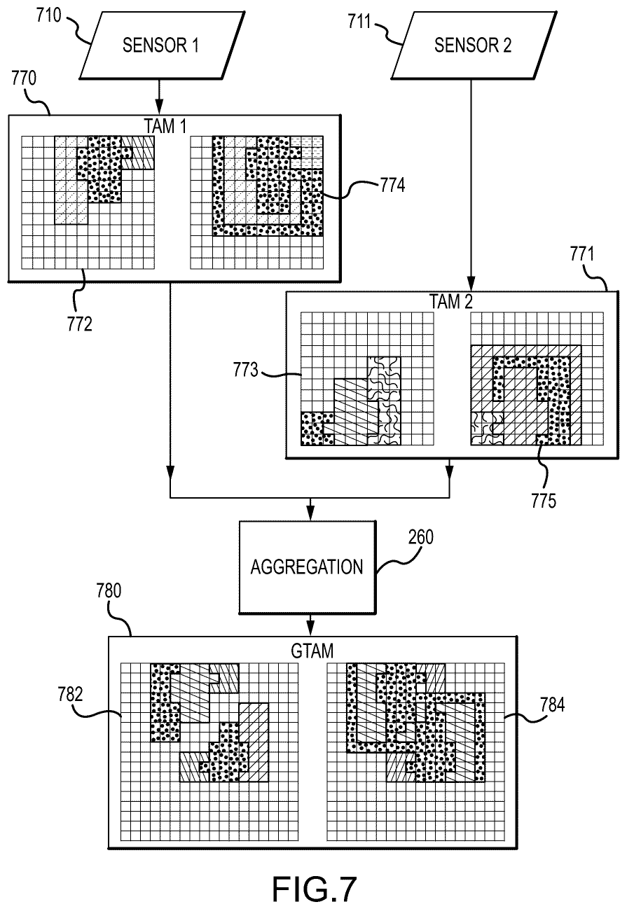

In addition to each sensor node producing its own TAM, TAMs from multiple participating sensor nodes may be combined into a system level map product, i.e., Global Temporally Aggregated Map (GTAM) through a global aggregation process. With reference to FIG. 7, a simplified block diagram depicts an exemplary process for creating a GTAM according to embodiments of the disclosed invention. A sensor node 1 710 collects data that is processed into TAM 1 770, having a data layer 772 and a quality layer 774. Sensor node 2 711 collects data that is processed into TAM 2 771, having a data layer 773 and a quality layer 775. While two sensor node outputs are shown, the GTAM may include additional sensor outputs. The aggregation module FIG. 2, item 260 receives TAM 1 and TAM 2 and performs the aggregation process to stack and weight the data layers 772, 773, and their corresponding quality layers 774, 775. The module outputs a GTAM 780 with a data layer 782 wherein each pixel represents the highest quality data collected for each area of land during a time interval, and wherein the geographic area covered by the data layer is the combined geographic coverage of the individual TAMs. The GTAM also includes a quality layer 784, wherein each pixel represents the quality score of the corresponding pixel in the data layer.

The time duration for a GTAM is determined by the duration of the component TAMs ads well as user settings. For example, if every sensor node in the system produces TAMs having a 5-minute duration, a 5 minute duration is used as the minimum GTAM duration available. Then a generation policy is set by the user, wherein other durations are established as useful and produced for display. Such durations may be 5 minutes, 15 minutes, 30 minutes, 1 hour, and 4 hours. Using the generation policy, the system then generates GTAMs having the specified durations, usually including a constituent TAM in several different GTAMs. For example, if sensor node 1 produces a TAM having a 5-minute duration with 12:00 timestamp, GTAMs produced by the system may include the TAM in each of the following GTAMs: 1) 12:00 to 12:05, 2) 12:00 to 12:15, 3) 12:00 to 12:30, 4) 12:00 to 1:00, and 5) 12:00 to 4:00. In some cases, a sensor node may provide TAMs at a lower time granularity, e.g., a satellite that only takes readings every 4 hours. The system would integrate the lower granularity TAM into GTAMs according to policies set by the user.

The resulting GTAM 780 is a single global georeferenced map, containing the information collected from all participating sensor systems during a time interval. The global aggregation process may generate a partial or preliminary GTAM using a subset of input data, then update map as new data arrives. Partial GTAMs can be exported for reduced export latency. Exported TAMs and GTAMs may be used as map displays for a cockpit display in an aircraft or may serve as input to other systems.

Georeferencing and time aggregation are interdependent processes. For purposes of time aggregation, the system may establish a timescale and time origin, e.g., 15-minute time slices with and origin of 1200 hours. Based on the selected timescale and origin, each sensor node locally sorts each of its readings according to the appropriate time range. Then sensor readings taken within the same time range are georeferenced onto a common map. Just as individual overlapping pixels are combined to produce a composite value for the pixel, overlapping images are also combined on the common map. By combining overlapping images, the dataset is effectively compressed by discarding redundant information. At the end of a time range, a sensor node transmits its combined map over the network back to the system's primary aggregator, which is usually hosted in cloud storage. Traditional compression techniques can further reduce the information quantity, for example, by applying PNG compression to the maps.

Orthorectification and time aggregation are accomplished in near real time using a low-power processor that may be locally housed on a sensor node. By performing such processing steps nearly simultaneously with the sensing function, the system assembles smaller aggregate files for transmission to ground stations because many discrete sensor observations are combined into one aggregated, orthorectified file, i.e., a TAM. Such TAMs are small enough to be transmitted over standard data links, at speeds on the order of kilobytes per second. Further, the TAMs provide improved situational awareness relative to their constituent sensor readings because the aggregated files depict a broader geographic area over a longer duration. In addition, the described process of aggregating singular sensor readings allows the construction of composite maps covering broader geographic areas by facilitating the coordination of geographic overlap among the aggregated files.

### Data Display

The end goal of data collection and processing as described is to provide a high-quality data display, FIG. 2, item 280, to the end user. Specifically, this means displaying the collected data in a terrain or 3-D relief map format that allows easy and effective analysis by the end user during disaster response efforts. The map interface is configured to allow users to pan and zoom to view different geographical regions, from different vantage points, for different time periods. Because data is aggregated and compressed, it can be collected from multiple sensor nodes and participating sources then used to populate the map interface quickly and robustly. Further, since the data received in near real time from multiple users, the map interface has tactical functionality. Access to the interface by a central command function allows decisionmakers to deploy resources based on timely, high-quality data displayed on the map interface. For example, evidence of a wildfire and its trajectory would allow deployment of firefighting aircraft to the proper location, while gaps in displayed data inform where to direct a sensor platform to collect additional sensor data.

Working from data samples and/or data arrays provided to a central cloud server, the data display function produces map sets from all available sensor nodes, including airborne and ground-based nodes. Time-coordinated weather characteristics stored in the weather database are displayed for the affected geographic region and relevant time period. These map sets can be displayed on a variety of user interfaces, such as in-flight display screens onboard aircraft, operational center video displays, a 3-D map of the globe, or other interactive applications. Additionally, this data can be offboarded to third-party applications via an Application Programming Interface (API), allowing for use with other tools and services. Map interface displays are highly configurable, allowing a system user flexibility and customization options.

Further, the inclusion of co-extensive quality maps with sensor data improves user interpretation of data, allowing for increased flexibility in configuring displays, and increased intuitive interaction with the system. For example, the quality map informs the transparency of data pixels, wherein higher quality data is presented as more opaque and lower quality data appears as more transparent. Similarly, data quality may be indicated by color coding pixels or regions of pixels, and/or applying different textures, flashing effects, or animations based on their quality score.

A user would be able to assess areas that have been scanned versus areas that have not been scanned, areas where data is recent versus areas where data is stale, or areas with reliable data on fire location versus areas with less certainty. Such rapid assessments can then drive decision making for asset deployment improving management effectiveness. In other words, pairing quality data with sensor data creates a map interface that is more intuitive to use than an interface using sensor data alone.

The low-latency and low-bandwidth transmission requirements of the system allow for real-time distribution of data for use in various tactical planning tools for disaster response personnel. To that end, other useful map-based information, e.g., asset positions, may be overlayed on system data for display on user display systems, such as the Automatic Dependent Surveillance-Broadcast (ADS-B) tracks of aircraft, GPS-based positions of ground personnel, etc. Through such tools, response personnel have access to minute-by-minute updates on the size, scale, and nature of the disaster. Further, where gaps in the data exist, the command-and-control function can direct sensing assets to the location, where data can be collected and rapidly added to the map interface. Given that disaster response occurs in highly dynamic and volatile circumstances, the tactical nature of the system provides substantial value to response personnel that is not currently available in the art.

The disclosed system is also configured to interface with public civilians potentially affected by a natural disaster, such as a wildfire. Both the disaster response interface and the civilian interface may be supported simultaneously. Through a modified map interface, civilians are provided access to the position and evolution of disasters in near real time, which is not available in existing commercial solutions. The disaster response interface includes a data push function allowing users to select data to provide to the civilian interface, e.g., wildfire position data, or evacuation area requests. Such functionality allows response personnel to use their expertise to provide situational awareness to the public.

### Layer Processors and Secondary Layer Generation

In addition to the primary layers, i.e., sensor data layer and quality data layer, other secondary data layers may be derived from system inputs and/or products and are contemplated herein. One particularly useful secondary layer is a Sensor Coverage Layer that displays areas that have not been imaged so that resources may be tasked or re-routed to image those areas, if required. Secondary layers may be produced from collected sensor data, geometric data, quality data, or may be derived from georeferencing outputs, time aggregation outputs, or quality scoring.

For example, a thermal imaging camera may collect thermography data, representing temperature of the ground, that is provided as an available layer, i.e., the primary layer. Concurrently, the temperature layer is also provided as input to a function that predicts fire boundaries. This fire boundary layer is then used as a secondary layer displayed along with or separately from the primary layer in the map display.

Secondary layer outputs are generated using a layer processor, which is an algorithmic function that accepts inputs in the form of data samples, primary layer outputs, and secondary layer outputs from other layer processors. Layer processors produce one or more secondary layers as outputs, and where a secondary layer comprises a data layer, a corresponding quality layer may be produced as well. Secondary layer quality scoring may reflect underlying data quality but may also indicate such values and as model certainty of prediction, e.g., a higher quality score indicates the predicted event is more likely. The map interface may include individual expression options for each layer set, and composite expression options to display multiple data layers as output.

In some embodiments, the system produces tertiary layer products. A tertiary layer is a layer that is produced from time dependent data sets, i.e., wherein longer timeframes or additional data are useful. For example, fire boundary prediction improves with additional sensor readings, so a tertiary layer processor would collect data over an interval until it had acquired enough data to reach a prediction certainty threshold.

### Incident Characterization Module

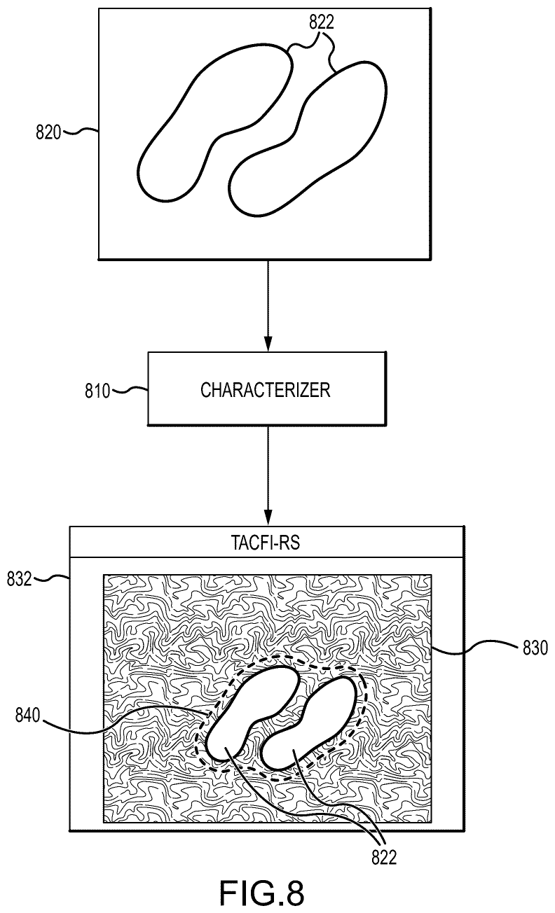

Among the capabilities of the disclosed system is an automated incident characterization module. For disaster management purposes, a critical task is the identification of the boundaries of a wildfire or other disaster incident. With reference to FIG. 8, a simplified block diagram depicts an exemplary process for characterizing an incident according to embodiments of the disclosed invention. The incident characterization module 810 uses TAMs or GTAMs 820 that contain bulk fire estimate data layers 822 to identify the boundaries of individual wildfire incidents. The characterizer assesses the data elements 822, queries the system database for existing incidents, and designates a boundary line 840 marking the location and geographic extent of the incident. Such assessments are based on factors such as existing incidents, distance between individual incident areas, physical continuity, relative movement, underlying geographical factors, and other suitable factors. Through use of the interactive map display 830 displayed on the TCFI-RS control panel 832, such automatic determinations may be evaluated and adjusted by users based on quality scoring or other suitable criteria. The fire estimate data overlay is layered onto a 2-D or 3-D map. Disaster response personnel may then use incident boundaries as a starting point for delineating disaster management jurisdiction, resource allocation, etc.

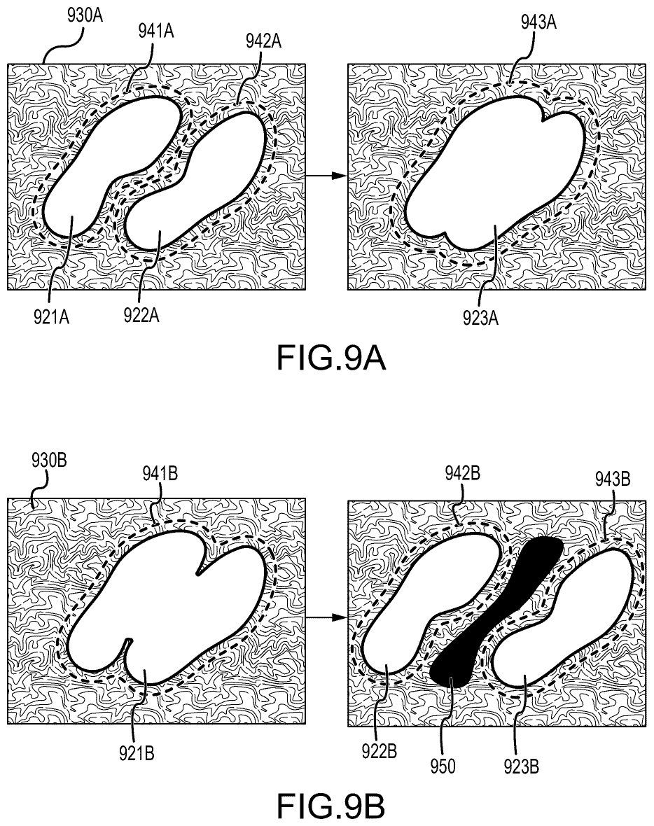

Boundary identification may also include discrimination between different adjacent wildfire incidents, which may be based on wildfire characteristics, e.g., burn temperature, fuel source; movement patterns; or geographic boundaries, e.g., presence of a body of water. Distinct wildfires may also merge or split over time, requiring the system to identify cases in which burning areas merge or diverge. With reference to FIGS. 9A and 9B, are pictured diagrams that depict an exemplary GUI display showing incident characterization according to embodiments of the disclosed invention. For example, an interactive map display 930A shows two separate incidents 921A, 922A marked by boundaries 941A and 942A, respectively. With the passage of time, if the incidents move closer together and eventually overlap, the characterization module will merge the incidents into one by redrawing the boundary 943A to contain the merged incident 923A. The characterization module will use information from the database as well as geographic or other factors to perform the characterization. Similarly, an interactive map display 930B shows a single incident 921B marked by a boundary 941B. With the passage of time, the contiguous burning area separates into multiple smaller contiguous areas, so the module will generate new incidents 922B, 923B with redrawn boundary lines 942B, 943B. In this case, a burned area 950 is shown between the incidents, further indicating that the incidents are now separate. Active burn areas are primarily estimated through use of data from participating thermal imaging sensors and visual sensors but may also incorporate LWIR imagery or other suitable external data products in combination with secondary and tertiary layer processors.

The characterization module also includes the ability to identify new disaster incidents. Upon receipt of a GTAM or TAM that includes an area estimated to be burning, the module queries a central holistic database to determine if an incident was previously detected at the potential fire location. If an incident has previously been identified at the location, the system proceeds to modify the incident using the new collected data. If no previous incident was detected, the module generates a new incident. The new incident is displayed on the map using a contour detection algorithm to characterize an outline of the burning area. Then the outline is bundled with other information generated about the incident and is added to the database and displayed as an “unassigned” incident.

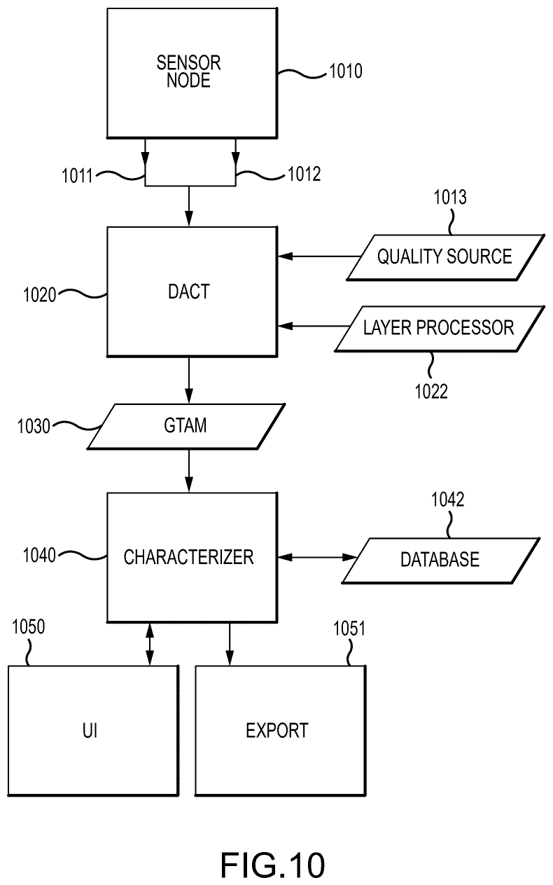

With reference to FIG. 10, a flow chart depicts layer processing and incident characterization within the system flow, according to embodiments of the disclosed invention. Participating airborne and ground sensors 1010 collect sensor data 1011 and metadata 1012 and send it to the DACT module 1020 for processing. DACT uses the data, metadata, and quality information from one or more quality sources 1013 to georeference and perform spatio-temporal aggregation. One or more secondary layers produced by a layer processor 1022 may be used as an input to the aggregation process. The characterizer 1040 receives GTAMs 1030 from the DACT module 1020 and performs incident characterization. Incident characterization relies on information stored in the system's holistic database 1042, and also contributes information about characterized incidents to the database. The characterizer displays incident designations on a user interface 1050, from which a user may alter characterizations as required. Data is also output for other purposes 1051.

### Incident Management Functions

### Jurisdiction Assignment

Various agencies are charged with managing incidents that occur within their purview. The remit for a particular agency may include federal or state lands in a geographic region, lands within the boundaries of a state, lands within county boundaries, etc. As such, an agency's purview likely overlaps with that of another agency, requiring primary responsibility for incident response to be allocated to a single agency. The disclosed system includes a jurisdiction assignment function that automatically recommends jurisdiction to an agency with authority over the geographical region containing a new automatically detected incident. The agency with recommended jurisdiction can then begin to manage the incident, or delegate jurisdiction to another agency. If an agency with recommended jurisdiction decides to manage the incident, the system includes an assignment function that allows the agency to assign resources to the incident and select an internal manager or team to execute the management function. If the recommended agency decides to delegate, the assignment function allows a notification to be sent to an outside agency to delegate jurisdiction to the outside agency.

### Dynamic Jurisdiction Assignment

Because natural disaster incidents are dynamic, initial jurisdiction assignments may require adjustment as the disaster response unfolds over time. For example, if a single wildfire splits into multiple incidents, the system assigns jurisdiction for the split incidents to the original incident owner and will flow down the agency's information to the split incidents. However, if two incidents with different owners merge, the system requires user input to assign jurisdiction of the new merged incident.

As another example, an incident under emergency management by an agency may move or spread into another agency's area of responsibility. In such cases, the jurisdictional policies of both affected agencies are used to assign jurisdiction to the incident. For example, an agency might require shared jurisdiction for incidents that come within their purview, an agency might require full jurisdiction, or require that the original emergency manager retain jurisdiction. An agency using the disclosed system may also set their jurisdiction assignment function to reflect their internal policies. For example, the jurisdiction assignment function may be set to automatically share jurisdiction with the agency(ies) that own parts of the incident, so that the new area covered by the incident is co-managed by the original owner and the new agency(ies). By contrast, an agency could instead set their assignment function to never share jurisdiction with another agency unless manually approved. With this setting, the system splits ownership of the incident along jurisdictional boundaries, so that there are now two incidents under different management. Another jurisdiction assignment function setting is co-ownership. If two agencies each have co-owning enabled, when an incident crosses boundaries, the entire incident area in each jurisdiction is granted to the opposite party so that both parties share ownership of the entire area.

As another example, the system tracks the geographic area burned within each jurisdiction to assist in allocating firefighting costs according to the acres burned in a given jurisdiction, or other similar metric.

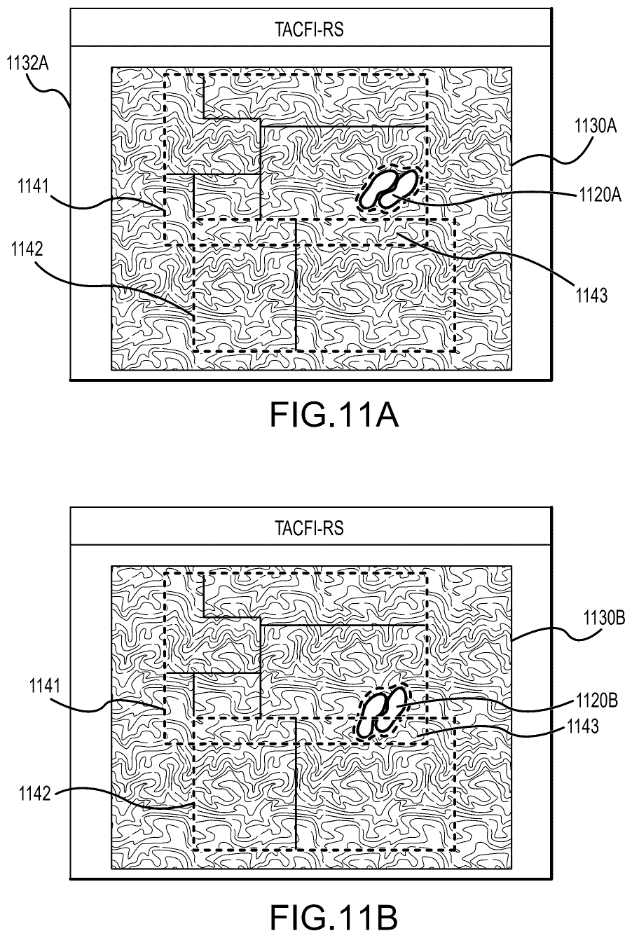

With reference to FIGS. 11A and 11B an exemplary GUI display is depicted showing dynamic jurisdictional assignment, according to embodiments of the disclosed invention. In FIG. 11A an interactive map 1130A displayed on the TCFI-RS control panel 1132A shows an incident 1120A located on the map at a first time period with north oriented toward the top of the figure. Also displayed are jurisdictional boundaries delineating the geographic areas of responsibility 1141, 1142 for a first Emergency Management Agency (EMA) 1 and a second EMA 2, respectively. An overlap area 1143 is present wherein the areas of responsibility overlap. As shown, the incident 1120A is fully within EMA 1's area of responsibility 1141, and accordingly, the jurisdiction assignment function assigns jurisdiction over the incident to EMA 1.

The areas or responsibility 1141, 1142 are displayed as interactive regions on the interactive map 1130A. For example, clicking within the boundary of an area of responsibility will cause a pop-up display to appear showing information about the agency in charge of the area, contact information about the manager, and other suitable information. Similarly, the incident 1120A is also interactive, so that clicking on the incident will cause a pop-up display to appear showing which agency has jurisdiction, assignment status, or other useful information.

In FIG. 11B, the interactive map 1130B shows the incident 1120B at a second, later time period. The incident has moved, and now is partially in the area of responsibility 1141 of EMA 1, and partially within the area of responsibility 1142 of EMA 2, that also happens to be the overlap area 1143 of shared responsibility. In this case, the jurisdiction assignment function would assign jurisdiction according to the policies of the two agencies. For example, if EMA 1 had a policy against sharing jurisdiction until manually approved by a user, the system would split the incident along the northern boundary of area 1142 and initially assign jurisdiction over the area north of the boundary to EMA 1 and assign jurisdiction to the area south of the boundary to EMA 2. The user may choose to affirm or reject the automatic jurisdiction assignment. By contrast, if EMA 1 had a policy of automatic sharing of jurisdiction if the incident moved into another agency's area of responsibility, the system would assign shared jurisdiction to EMA 1 and EMA 2. The receiving agency's policies also play a role in jurisdiction assignment. For example, EMA 2 may have a policy requiring the original agency with jurisdiction to retain jurisdiction, and accordingly, the system would leave the incident 1120B under the jurisdiction of EMA 1.

### TACFI-RS Sensor

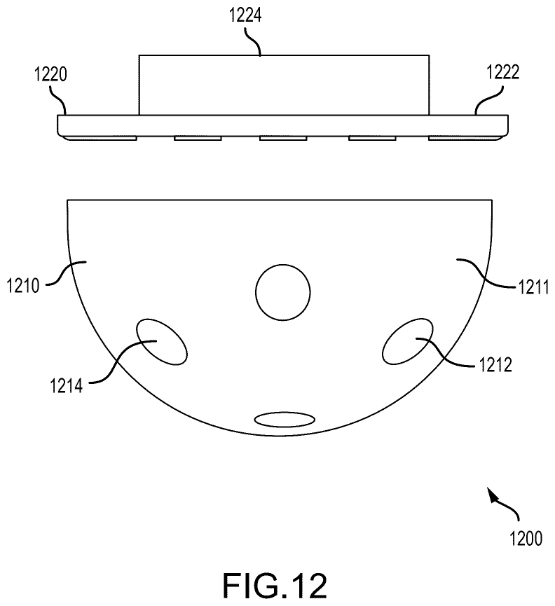

With reference to FIG. 12 is depicted an exploded side view of a sensor system 1200 configured to participate in the TACFI-RS system as used in embodiments of the disclosed invention. The sensor includes a sensor dome assembly 1210 and an adapter plate 1220. The dome assembly includes a dome 1211 for containing and protecting the sensing apparatus. The dome includes a plurality of openings 1212, each of which is configured to accommodate a sensor aperture 1214. The dome assembly is configured to removably attach to the adapter plate 1220, which is permanently installed on an aerial vehicle, or in some embodiments a ground station. The adapter plate includes a mounting platform 1222 for mechanically interacting with the dome assembly, and a flange 1224 for fitting inside the wing or fuselage of an aircraft, or a mounting location on a ground station.

Use of a modular dome assembly and adapter plate allows a common dome assembly design to be used with multiple, heterogenous platforms, since only the adapter plate needs to be configured to each platform. For example, a sensor system may be mounted underneath the wing of an aircraft, wherein the adapter plate must be configured with a specific bolt pattern to interface with the wing's skin. On another installation, a sensor system is mounted on the belly of a UAS, and the adapter plate must be configured with a specific rivet pattern for proper attachment. It is desirable to maintain a single dome assembly across multiple platforms to improve interoperability among systems and to reduce engineering overhead. By using a tailored adapter plate for each platform's requirements, the dome assembly can remain standard and interchangeable, and specific mounting requirements for each platform are accommodated within the adapter plate component.

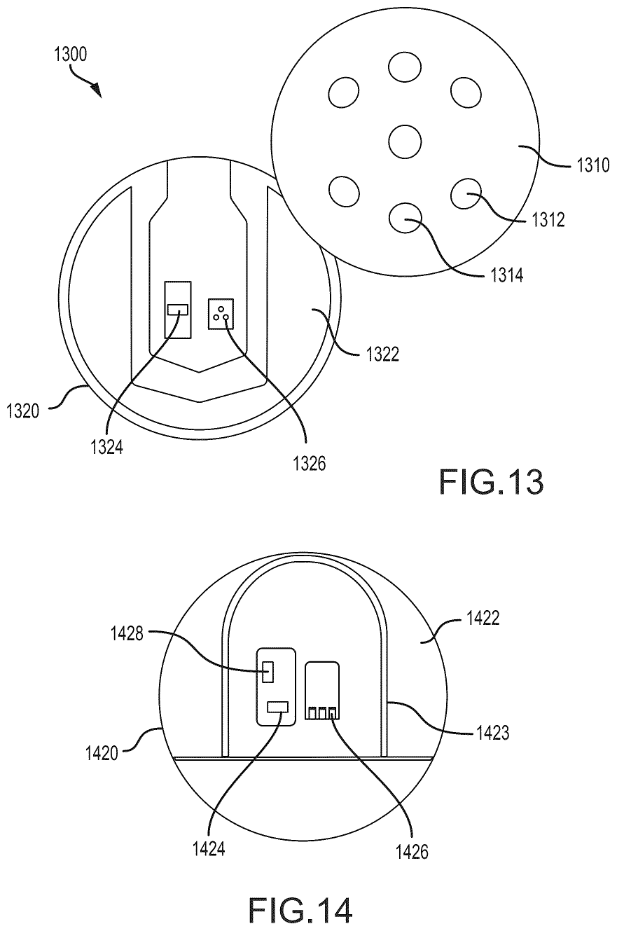

With reference to FIG. 13 is shown an exploded bottom view of the sensor system 1300. In this view the sensor dome assembly 1310 is shown detached from the adapter plate 1320. On the dome are visible the openings 1312 and sensor apertures 1314, in this case the sensor system supports seven sensors that are oriented to cover the geographic area underneath an aerial vehicle. The sensors are arranged to provide broad and overlapping coverage of the geographic area but may be tailored extensively to suit particular applications and flight profiles. As such, the quantity and arrangement of sensors is not critical for system operation, and multiple arrangements are possible and contemplated.

An exemplary sensor arrangement is shown wherein the sensors are pointed orthogonally to the surface of the dome. One such sensor is located at the apex of the dome pointing down, one is located on the dome centerline pointing forward, one is located on the centerline pointing aft, one is off centerline pointing to the front left quadrant, one is off centerline pointing to the front right quadrant, one is off centerline pointing to the rear left quadrant, and one is off centerline pointing to the rear right quadrant.

On the adapter plate 1320, a mounting platform 1322 is shown for mechanically and electrically interacting with the dome assembly. The mounting platform includes connectors for mating the dome assembly to the aircraft. A combined data and power connector 1324 allows the transmission of data from the sensors to the aircraft systems, and supplies power to the sensor apparatus. Radiofrequency (RF) connectors 1326 allow communication of GPS information and access to wi-fi networks. The adapter plate includes memory for storing information about certain aircraft systems to be used by the sensing apparatus.

Stored information can include platform-specific attributes, such as the positions of GPS antennas, type of installed INS equipment, the presence of map processing resources, tail number, etc. Because platform-specific information is stored on the adapter plate, which is permanently attached to the platform, the dome assembly and corresponding programming remains interchangeable and agnostic to platform. When the dome assembly is powered on, a dome assembly processor reads the relevant information from the adapter plate and configures the system without requiring input from a system user. The tailored adapter plate with interchangeable dome assembly allows, for example, a user to purchase an adapter plate for each aircraft in their fleet, and a smaller number of dome assemblies. The dome assemblies may be attached to a subset of the fleet as needed just prior to a mission, with no additional configuration required. Interchangeable dome assemblies can also be easily installed in the event of a dome assembly malfunction, increasing system uptime and easing repair logistics. Lastly, in the event that a platform must be flown or transported in circumstances likely to cause sensor damage, such as through a hailstorm, the dome assembly may be removed for transport and reinstalled once the risk has been mitigated. While a dome assembly is not installed, a closeout plate is removably installed to protect the connectors housed within the adapter plate.

With reference to FIG. 14 is depicted a top view of the adapter plate 1420, showing an attachment surface 1422 that mechanically and electrically interacts with the airborne platform. A flange 1423 for interacting with the aircraft or other platform is shown. A combined data and power connector 1424 allow the dome apparatus to exchange data with the aircraft, and supply aircraft power to the dome apparatus. A set of RF connectors 1426 connect the dome assembly to aircraft systems to supply GPS information and wi-fi network connectivity to the dome assembly. Also shown is a memory chip and a microcontroller 1428 for storing information about the platform and for processing data output by the sensor apparatus. In some embodiments, instead of a microcontroller, a set of passive chips such as EEPROMs, ethernet controllers, and USB multiplexers, are used.

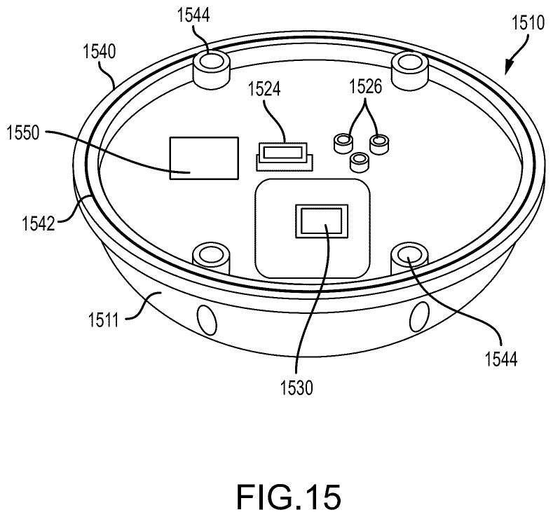

With reference to FIG. 15 is depicted a perspective view of the top of the dome assembly 1510. The dome 1511 is visible, as is an interface 1540 for mechanically interacting with the mounting platform of the adapter plate (see FIG. 13, item 1322). The interface includes an O-ring 1542 for sealing against the mounting platform, and a plurality of holes 1544 for mounting screws to secure the dome assembly to the adapter plate. A combined data and power connector 1524 is configured to interact with the data and power connector on the mounting platform (see FIG. 13, item 1324), and RF connectors 1526 are configured to interact with the RF connectors on the mounting platform (see FIG. 13, item 1326). The dome assembly includes an electronics suite that includes a processor 1530 for processing sensor data. The processor is preprogrammed with a compression algorithm, such as is described above, see the discussion around FIG. 2, items 240-260, to facilitate low bandwidth, low latency transmission to the cloud. An INS 1550 supplies PNT data to the sensor system.

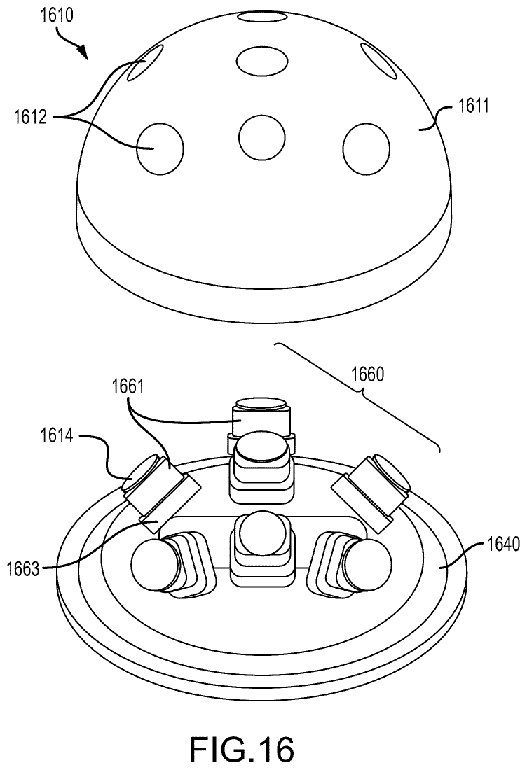

With reference to FIG. 16 is depicted an exploded perspective bottom view of the dome assembly 1610. As shown, the dome 1611 is removed from the mounting platform 1640 to show the primary sensor suite 1660 that includes seven individual sensors 1661. Each sensor includes an aperture 1614 and a camera 1663. The sensors may include a microbolometer infrared camera, a visual camera, or other suitable optical sensors. Each primary sensor 1661 is preferably small, uncooled, and non-gimballed, which allows for efficient data collection over a large field of regard. In some embodiments, the dome assembly also includes an array of secondary sensors (not shown) that provide contextual data required to inform and interpret the collected primary sensor data. Secondary sensors may include a visual sensor, an optical sensor, a depth sensor, a location sensor, or a position sensor. The secondary sensors are preferably low-cost, uncooled sensors to ensure the overall sensor systems are simple, cheap, and suitable for deployment in large numbers. The primary sensor suite, and any secondary sensors, are in electrical communication with the electronics suite, and supplies data through the data connector to the aircraft. Each aperture fits through a corresponding opening 1612 in the case 1611.

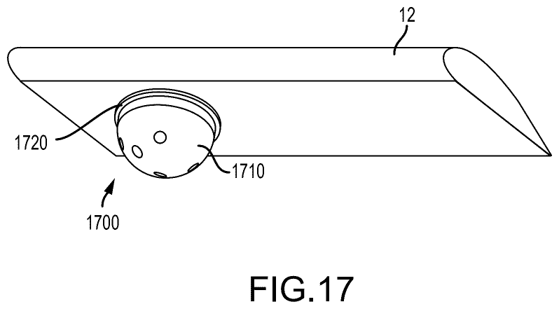

With reference to FIG. 17 is shown a perspective bottom view of a sensor system 1700 mounted to the underside of an aircraft wing 12. The sensor dome assembly 1710 is removably mounted to the adapter plate 1720, which is mounted permanently to the wing.

Another aspect of the disclosed invention is a procedure for retrofitting existing aircraft with a sensor system configured to participate in the TACFI-RS system as described herein. Incident response, particularly wildfire management, often requires the participation of many different aircraft of many different types, e.g., helicopters, fixed wing aircraft, piloted aircraft, unpiloted aircraft (UAV), tankers, transports, etc. However, few participating aircraft in service above incident areas are equipped to collect data. One key reason for this lack of capability is that existing sensor systems are bulky, expensive, and typically require a dedicated platform. Therefore, in order to increase the amount of sensor data available to disaster managers, the disclosed method allows for retrofitting of smaller aircraft with the disclosed sensor systems, so that each participating aircraft becomes a sensor node. Large-scale sensor deployment using available airborne platforms creates a large total sensor field of view for more complete coverage of a geographic area.

In some embodiments, the primary sensors, including, for example, long wave infrared cameras, and an inertial measurement system (INS) are both mounted to a rigid structure, such as an aluminum dome. Attaching the INS and cameras to the same rigid, thermally stable structure, allows the system to perform a calibration step to precisely determine sensor alignment. Such calibration is performed on a per-camera, per-pixel basis to determine the relative alignment between the INS and each pixel, and thus accounts for camera mounting positions, INS mounting position, and manufacturing tolerances, such as lens distortion etc. Alignment information is stored in dome assembly memory, and facilitates dome assembly interchangeability, and maintains sufficient alignment accuracy necessary to perform georeferencing. Calibration also allows sensor cameras to be mounted in one of many positional configurations. Positional flexibility enables camera position to be customized without changing the underlying compression algorithm. For example, a fast, high-altitude fixed-wing aircraft may require an array of downward facing, narrow field of view cameras, whereas a slow, low-altitude drone may require a set of symmetrically mounted wide field of view cameras. Since alignment is referenced to each pixel of each camera, the compression algorithm is agnostic to the camera configuration, and wide customization is supported.

Although the sensor dome may be manufactured using a variety of processes and materials, it is preferred to use a thermally conductive material, e.g., a metal, to dissipate heat generated by the sensors and onboard processors. For sensor systems mounted on airborne platforms, a conductive sensor dome contacts, and is cooled by, the large volume of air from the aircraft slipstream. Sensor components within the dome are configured to conduct any heat generated to the dome component, to facilitate reliable and effective cooling.

In some embodiments, a secondary processor, i.e., a map processor, is mounted in the airborne platform to supplement the processing capacity of the dome assembly. The map processor includes one or more CPUs and/or GPUs that communicate with the dome assembly through internet protocol, e.g., ethernet or wi-fi. The map processor is configured to perform computationally intensive algorithms to improve georeferencing results, wildfire detection, and other functionalities.

Once installed, a sensor assembly operates a parasitic mission concurrently with the airborne platform's primary mission. The aircraft's original assigned mission profiles can be flown despite the presence and operation of the sensor assembly, and no pilot or other airborne user input is required for sensor operation. However, the airborne platform may be tasked to fly a sensor-specific mission or add such a mission to its existing profile when required.

### Airborne Control Software Application

In some embodiments, the sensor system hosts a software application that is accessible on the aircraft's local area network. The app includes a graphical user interface (GUI) that allows a user to control the sensor system and view camera/sensor output. From the app, a user may selectively start or stop data collection by one or more sensors, downlink a map product, or check a status indication for subsystems such as cameras, INS, and internet link. Under normal operation, the system automatically downlinks map products, i.e., TAMs, GTAMs, according to a set schedule, usually every 5 or 10 minutes. However, using the app, a user may downlink a TAM at any time to provide additional or more timely sensor data to the ground control station. In addition to control functions, the app allows the user to display a livestream feed from each camera, a combined view of all cameras, or other suitable display. The app also includes a 3-D viewer for displaying TACFI-RS map products.

Due to network constraints, the 3-D viewer hosted on the airborne app displays a less data intensive view relative to the cloud-based Data Display interface accessible through the ground control station. A typical TACFI-RS airborne asset uses a satellite modem to communicate with cloud-based servers. Because such satellite datalinks are typically slow and expensive to operate, it is desirable to minimize the amount of data transfer they are required to accomplish. Further, a system user onboard the airborne asset would have similarly limited networking resources available to access the Data Display. Despite this, providing an airborne user access to the imagery collected locally presents substantial operational advantages, including the user's ability to improve situational awareness.

To compensate for such bandwidth limitations, the airborne 3-D viewer displays TAMs as a reduced bandwidth product that is communicated over the aircraft's high bandwidth local area network and is thus independent of the bandwidth available to the aircraft for communication with the ground. Using only the local area network to display TAMs in-flight avoids use of limited satellite downlink bandwidth and reduces costs and complexity. In this configuration, the sensor system will cache TAMs and other data until an internet connection can be established, such as through a Wi-Fi access point, cellular network, or other high bandwidth connection. If higher bandwidth is available, the user can configure the app to uplink map products from the cloud server so that the airborne user has complete datasets from all sensor platforms for maximum situational awareness.

### Computer System

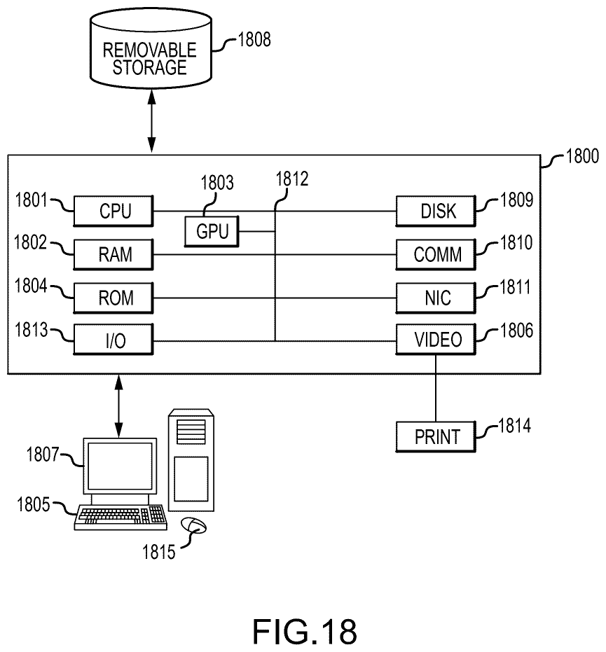

One having skill in the art will recognize that portions of the disclosed invention may be implemented on a specialized computer system, or a general-purpose computer system, such as a personal computer (PC), a server, a laptop computer, a notebook computer, or a handheld or pocket computer. Those skilled in the relevant art will also recognize how to implement the invention using other computer systems or architectures. FIG. 18 is a general block diagram of a general-purpose computer system in which software-implemented processes of the disclosed invention may be embodied. As shown, the system 1800 comprises one or more central processing unit(s) (CPU) or processor(s) 1801 coupled to a random-access memory (RAM) 1802, a read-only memory (ROM) 1804, a keyboard or user interface 1805, a display or video adapter 1806 connected to a display device 1807 (e.g., screen, touchscreen, or monitor), a removable storage device 1808 (e.g., flash drive, floppy disk, cloud storage, etc.), a fixed storage device 1809 (e.g., hard disk, flash memory), a communication (COMM) port(s) or interface(s) 1810, and a network interface card (NIC) or controller 1811 (e.g., Ethernet, wi-fi, cellular, near-field communication, etc.). Some embodiments may include a graphics processing unit(s) (GPU) 1803 to supplement or perform data processing. Although not shown separately, a real time system clock is included with the system 1800, in a conventional manner.

The CPU 1801 comprises a suitable processor for implementing the disclosed invention. In some embodiments, a GPU 1803 may supplement computational tasks as is known in the art. In some embodiments, the processor 1801 may be an Artificial Intelligence (AI) processor, which may be implemented as a Tensor Processing Unit (TPU), or a graphical processor unit, or a custom programmable solution Field-Programmable Gate Array (FPGA). The CPU 1801 communicates with other components of the system via a bi-directional system bus 1812, and any necessary input/output (I/O) controller 1813 circuitry and other “glue” logic. The bus, which includes address lines for addressing system memory, provides data transfer between and among the various components. RAM 1802 serves as the working memory for the CPU 1801. ROM 1804 contains the basic I/O system code (BIOS), which is a set of low-level routines in ROM that application programs and the operating systems can use to interact with the hardware, including reading characters from the keyboard, outputting characters to printers 1814, etc.

Mass storage devices 1808, 1809 provide persistent storage on fixed and removable media, such as magnetic, optical, or magnetic-optical storage systems, flash memory, cloud servers, or any other available mass storage technology. The mass storage may be shared on a network, or it may be a dedicated mass storage. As further shown in FIG. 18, fixed storage 1809 stores a body of program and data for directing operation of the computer system, including an operating system, user application programs, driver, and other support files, as well as other data files of all sorts. Typically, the fixed storage 1809 serves as the main data storage for the system.

In operation, program logic (including that which implements methodology of the disclosed invention described herein) is loaded from the removable storage 1808 or fixed storage 1809 into the main (RAM) memory 1802, for execution by the CPU 1801. During operation of the program logic, the system 1800 accepts user input from a keyboard and pointing device 1815, as well as speech-based input from a voice recognition system (not shown). The user interface 1805 permits selection of application programs, entry of keyboard-based input or data, and selection and manipulation of individual data objects displayed on the screen, touchscreen, or display device 1807. Likewise, the pointing device 1815, such as a mouse, track pad, track ball, pen device, or a digit in the case of a touchscreen, permits selection and manipulation of objects on the display device. In this manner, these input devices support manual user input for any process running on the system.

The computer system 1800 displays text and/or graphic images and other data on the display device 1807, or may output to audio speakers, vibrating motor, LED lights, etc. The video adapter 1806, which is interposed between the display 1807 and the system bus, drives the display device 1807. The video adapter 1806, which includes video memory accessible to the CPU 1801, provides circuitry that converts pixel data stored in the video memory to a raster signal suitable for use by a display monitor. A hard copy of the displayed information, or other information within the system 1800, may be obtained from the printer 1814, or other output device.

The system itself communicates with other devices (e.g., other computers, other networks) via the NIC 1811 connected to a network (e.g., Ethernet network, wi-fi, near field communication network, etc.). The system 1800 may also communicate with local occasionally connected devices (e.g., serial cable-linked devices) via the COMM interface 1810, which may include a serial port, a Universal Serial Bus (USB) interface, or the like. Devices that will be commonly connected locally to the interface 1810 include desktop computers, laptop computers, handheld computers, etc.

The system may be implemented through various wireless networks and their associated communication devices. Such networks may include mainframe computers, or servers, such as a gateway computer or application server which may have access to a database. A gateway computer serves as a point of entry into each network and may be coupled to another network by means of a communications link. The gateway may also be directly or indirectly coupled to one or more devices using a communications link or may be coupled to a storage device such as a data repository or database.

In light of the above-mentioned advantages and the technical advancements provided by the disclosed methods and systems, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described methods and systems for identifying and managing natural disaster incidents, some of which may be accomplished through Artificial Intelligence (AI) models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the disclosed invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the disclosed invention is in no way limited to implementation in any specific programming language, or for any specific operating system or environment. Accordingly, the disclosure of the disclosed invention is intended to be illustrative, but not limiting, of the scope of the invention.

What is claimed is:

1. A computer-implemented method, the method comprising:
collecting data from a sensor, wherein the data includes a sensor value assigned to a pixel, and wherein the pixel is one of a plurality of pixels in an image plane of the sensor;
processing the data to remove a subset of the data characterized as irrelevant;
georeferencing the processed data, wherein each pixel of the plurality of pixels is associated with a geographic area to create a sensor value map;
rating the georeferenced data, wherein each pixel of the plurality of pixels is assigned a quality score to create a quality map;
aggregating the georeferenced data over time, using the sensor value map and the quality map, to create a map product; and
outputting the map product.

2. The computer-implemented method of claim 1, further comprising:
identifying a sensor that is producing sensor data; and
determining if the sensor data is suitable to contribute to the map display.

3. The computer-implemented method for generating a map display of claim 1, wherein the data is one of the following imagery types: thermal, visual, infrared, or ultraviolet.

4. The computer-implemented method of claim 1, the processing step further comprising:
collecting values for each pixel of the plurality of pixels in the image plane;
estimating, using time data and a solar positioning model, a position of the sun;
calculating, using the position of the sun and information about terrain under the sensor, a primary angle and a retroreflective angle from the position of the sun to the sensor;
predicting, using the primary angle and the retroreflective angle, a location of a reflection of the sun on the image plane; and
masking, using the location, one or more redacted pixels.

5. The computer-implemented method of claim 1, the georeferencing step further comprising:
tracing, using a location of the sensor and a pointing angle of the sensor, a ray propagating from the pixel toward a surface of the earth;
identifying, using a terrain model, a location where the ray intersects the surface of the earth;
assigning the sensor value to the location; and
assigning the sensor value for each pixel of the plurality of pixels to a location on the surface.

6. The computer-implemented method of claim 1, the rating step further comprising:
accounting for one or more of the following quality factors for the sensor value: an atmospheric condition, a type of sensor platform, a recency of a measurement, a geographic scale of each pixel of the plurality of pixels, a camera angle of the sensor, and a noise level of the sensor.

7. The computer-implemented method of claim 1, the rating step further comprising:
combining a first quality map with a second quality map to create a composite quality map.

8. The computer-implemented method of claim 1, the aggregating step further comprising:
calibrating a plurality of sensor value maps collected over a period of time using a calibration image;
stacking the plurality of sensor value maps, wherein the geographic area corresponding to each pixel is coordinated for each of the plurality of sensor maps;
selecting an aggregated sensor value for each of a plurality of aggregated pixels to create an aggregated sensor value map, wherein the aggregated sensor value represents a best quality sensor value for each aggregated pixel of the plurality of aggregated pixels; and
rating the aggregated sensor value, wherein each aggregated pixel of the plurality of aggregated pixels is assigned a quality score to create an aggregated quality map.

9. The computer-implemented method of claim 1, wherein the map product includes an aggregated sensor value map and an aggregated quality map.

10. The computer-implemented method of claim 1, further comprising: characterizing, using the map product, a boundary of a natural disaster incident.

11. The computer-implemented method of claim 10, further comprising: assigning, using the boundary, an agency having jurisdiction over the natural disaster incident.

12. A system for generating a map display, the system comprising:
one or more airborne sensors for collecting data over a geographic area, wherein the sensor(s) include position, navigation, and timing equipment;
one or more ground-based sensors for collecting data over the geographic area;
a ground control station that includes a geographic database and a computer system; and
a remote server in electronic communication with the one or more airborne sensor(s), the one or more ground-based sensor(s), and the ground station.

13. The system for generating a map display of claim 12, wherein the one or more airborne sensor(s) and one or more ground-based sensor(s) include a microbolometer sensor, a camera, a thermal mosaic camera, an infrared sensor, or a thermal imaging sensor.

14. The system for generating a map display of claim 12, wherein the one or more airborne sensor(s) is mounted on a satellite in Low Earth Orbit, a satellite in Very Low Earth Orbit, an unmanned aerial vehicle, a manned aerial vehicle, a commercial airliner, a hot air balloon, or a general aviation aircraft.

15. The system for generating a map display of claim 12, further comprising a DACT module that includes software for performing aggregation, compression, and transmission of collected data.

16. The system for generating a map display of claim 12, wherein the remote server communicates by use of one or more of the following: a cellular network, a satellite network, a radio network, an ethernet network, or a line-of-sight communication network.

17. The system for generating a map display of claim 12, wherein the one or more airborne sensor(s) and one or more ground-based sensor(s) perform data aggregation and compression using an onboard processor.

18. The system for generating a map display of claim 12, further comprising a characterizer module including software for interpreting collected data, wherein the characterizer module performs one of the following: identifies a new natural disaster incident, identifies a boundary of a natural disaster incident, or adjusts the boundary of a natural disaster incident.

19. The system for generating a map display of claim 12, further comprising a layer processor module including software for generating a secondary layer of data to augment the data display, wherein the secondary layer is derived from one of the following: sensor data, geometric data, quality data, georeferencing outputs, time aggregation outputs, or quality scoring.

20. The system for generating a map display of claim 12, further comprising a management module including software for assigning responsibility for a natural disaster incident to an agency, wherein the management module accounts for one of the following: a location of the natural disaster incident, a set of jurisdictional boundaries, or a set of policies for assigning jurisdiction.
